(19) United States
(12) Patent Application Publication
(10) Pub. No.: US 2019/0122458 A1
(43) Pub. Date: Apr. 25, 2019

(54) NVH AND WEAR DETECTION IN AUTONOMOUS VEHICLES

(71) Applicant: Continental Automotive Systems, Inc., Auburn Hills, MI (US)

(72) Inventor: Jörg Scheibel, Lake Orion, MI (US)

(73) Assignee: Continental Automotive Systems, Inc., Auburn Hills, MI (US)

(21) Appl. No.: 16/132,444

(22) Filed: Sep. 16, 2018

Related U.S. Application Data
(60) Provisional application No. 62/561,418, filed on Sep. 21, 2017.

(51) Int. Cl. G07C 5/08; G07C 5/00

(52) U.S. Cl. CPC G07C 5/0808; G07C 5/006; G07C 5/085

(57) ABSTRACT

One general aspect includes a method of diagnosing a mechanical problem on a vehicle including: collecting data from individual sensors, determining from the data whether is an NVH issue on the vehicle, and providing an alert when there is an NVH issue detected.

### TECHNICAL FIELD

The invention relates to a method of servicing automated driving systems for a motor vehicle, in particular for mechanical components.

### BACKGROUND

The increasing availability of technology has led to automotive vehicle becoming more automated. In particular, safety systems which assist in braking and steering in emergency situations make driving such vehicles safer. Further communications between vehicles, or vehicle and infrastructure is also becoming more popular to provide traffic and safety information to and/or from vehicles.

Vehicle-to-X communications is currently in a phase of development and standardization. This term is understood to mean in particular communication between vehicles (vehicle-to-vehicle communication) and communication between vehicles and infrastructure (vehicle-to-infrastructure communication).

With the increase in technology the driver interaction with the vehicle control systems is decreasing. With fully autonomous guidance the vehicle can maneuver itself independently in traffic and thus completely unburden the driver of the vehicle operation. As these systems become more independent the need to provide HMI and other controls available in the passenger compartment to the driver is less important.

Diagnostics of electrical components can be used to determine when they are not functioning properly or when they may need repair. However such diagnostics cannot be run on mechanical components and in traditional vehicles the mechanical systems rely on the driver sensing the problem. However, in an autonomous vehicle without a driver there may not be a person to detect a problem which a mechanical component. That is, without the interaction with a driver the problem may not be sensed by a mere passenger.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

One general aspect includes a method of diagnosing a mechanical problem on a vehicle including: collecting data from individual sensors, determining from the data whether is an NVH (noise, vibration, harshness) issue on the vehicle, and providing an alert when there is an NVH issue detected.

Implementations may include one or more of the following features. The method where determining whether there is an NVH issue further includes: diagnosing a performance level for each of the components; comparing the performance level for each component to a component performance standard; determining service of that component is desired based on the comparison; The method where the diagnosing a performance level for each component includes at least one of: comparing the component performance to performance of the same component on other modules in the fleet, and to a standard performance level for that component for vehicles of a similar type, and to a standard performance level for that component for vehicles of similar usage. The method where the component performance standard includes at least a first category for acceptable performance, a second category for degrading performance in which service will be desired within a predicted amount of time, and a third category for unacceptable performance in which service will be desired at the earliest opportunity. The method where the component performance standard includes a fourth category of performance which is inoperable until service is performed. The method further including instructing a controller on the vehicle to drive to a preset location at a preset time for service.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 shows a schematic exemplary illustration of a first embodiment of a vehicle of the present invention.

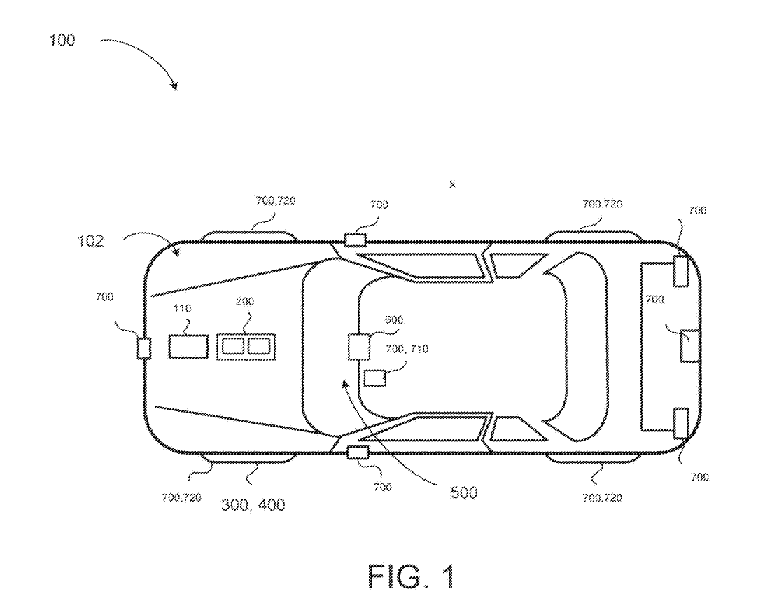

FIG. 2 shows a schematic exemplary illustration of a vehicle and system architecture for the vehicle of FIG. 1.

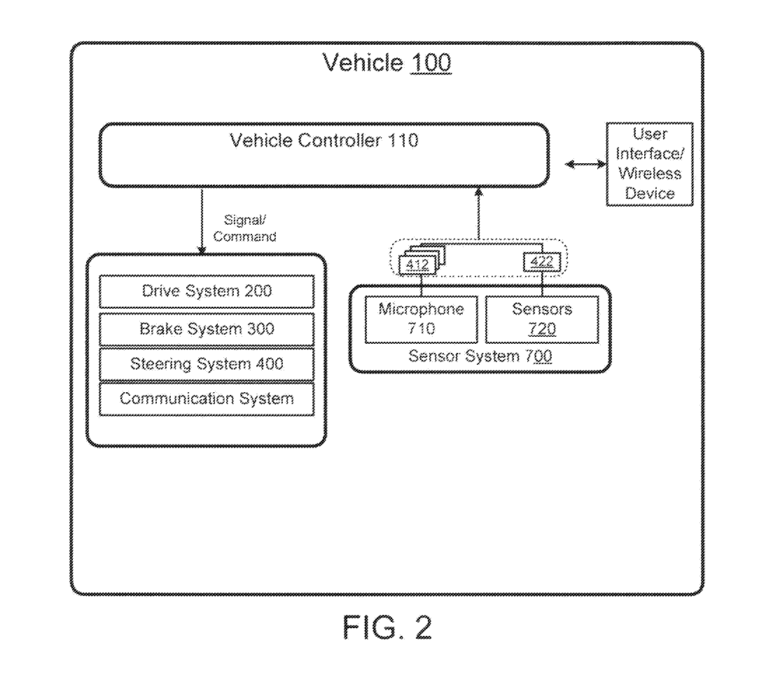

FIG. 3 shows a first exemplary illustration of a method for diagnosing the vehicle of FIGS. 1-2.

### DETAILED DESCRIPTION

The following description is merely exemplary in nature and is in no way intended to limit the disclosure, its application, or uses. For purposes of clarity, the same reference numbers will be used in the drawings to identify similar elements. The Figures illustrate schematic views of an exemplary vehicle 100, which is able independently operable to brake and steer itself. The vehicle 100 has a drive systems 200, a brake system 300, a suspension system 400, a steering system 500 and communication system 600. The vehicle 100 has a controller 110 connected which is in communication with all of the systems, which may each have their own controllers as well.

The vehicle 100 has a sensor system 700 for sensing the environment around the vehicle 100 and within a passenger compartment 120 of the vehicle. The sensor system 700 may include different types of sensors that may be used separately or with one another to create a perception of the vehicle's environment that is used for the vehicle 100 to autonomously drive and make intelligent decisions based on objects and obstacles detected by the sensor system 700. The sensors may include, but not limited to, one or more imaging devices (such as cameras), radar, sonar, LIDAR (Light Detection and Ranging, which can entail optical remote sensing that measures properties of scattered light to find range and/or other information of a distant target), LADAR (Laser Detection and Ranging), etc.

The vehicle 100 requires the sensor input to provide the autonomous instructions for driving, braking and steering itself. Various cameras and sensors may be connected to the controller 110 for determining the autonomous driving instructions. Redundant sensing and communication can be provided for safety between the autonomous controller 110 and the drive 200, brake 300 and steering systems 400. The communication system 600 can provide for sending and receiving information between the various vehicle systems. The controller 110 can direct the various systems with the necessary instructions for providing vehicle functions. Further, the communication system 600 may also be capable of handling communication between the vehicle 100 and other vehicles or infrastructure, V to X communications.

Data is collected through various sensorics and or algorithms regarding the performance of components. The data can be used to improve the features and functions of the components. Such data also enables proactive preventive maintenance of components via prognostic capabilities and improves serviceability of components. The system would offer data collected through various sensorics and or algorithms regarding the performance of our components to OEMs to improve their features and functions. The system would offer designs including realization of functional safety features and functions for the application of these concepts to meet functional safety requirements for various levels of autonomous driving.

Additionally, the sensors may be monitored to detect mechanical problems such as wear. Microphones 710 in the passenger compartment 120 or externally mounted on the vehicle can detect noises such as squeals, or rattles, etc. For example, an external microphone may detect brake noise. Other sensors 720 can detect NVH resulting from mechanical weal, e.g. suspension joints, ball joint war, tie rod wear, bearing wear/NVH, steering rack or motor wear/noise, cooling pump NVH, drive shaft NVH, etc. Diagnostic algorithms in the vehicle controller 110 can monitor the microphones 710 and sensors 700, 720 to assess the detect data of being indicative of a mechanical failure. Other sensors 700, 720 already incorporated onto the vehicle can also be used, such as acceleration sensors, wheel speed sensors, etc.

Data from the vehicle can be used to monitor vehicle for current, suspected, or predicted performance and maintenance. Therefore the system and method may provide a service which prognosticates and/or diagnoses to schedule repair or preventative maintenance. Based on the predicted or diagnosed purpose the system may schedule such service with the vehicle through a communication device. Such scheduling would be based on severity of the repair and/or maintenance required, predicted vehicle mileage, length of the repair and/or maintenance service time, etc. The prognosis and/or diagnosis is performed by the system and is based on the vehicle information and general vehicle and component performance information, and fleet management information. Alternately, the system could provide an alert to the vehicle owner through a wireless communication, or by an on-board alert. Additionally, the vehicle owner and/or a vehicle user may be given an option to confirm the diagnosed problem.

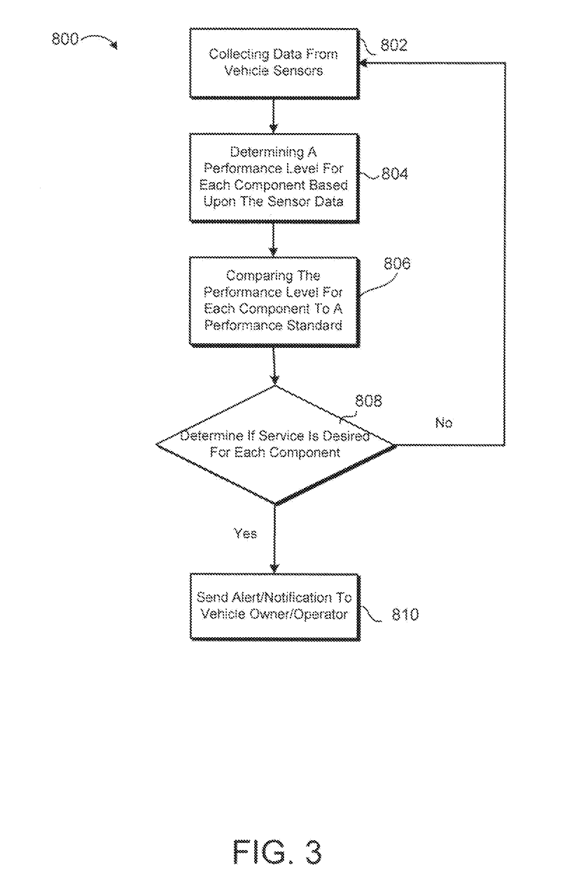

Referring to FIG. 3, a method of diagnosing a mechanical problem on a vehicle is illustrated generally at 800. The diagnosing of a problem includes collecting data from individual sensors, shown at 802, determining from the data whether is an NVH issue on the vehicle, shown at 804-808, and providing an alert when there is an NVH issue detected, 810.

For example, a noise or vibration may be detected by one of the sensors (including microphones) 700, 710, 720. Input from the wheel speed sensor can be used to determine at what frequency such NVH is occurring. Frequency of NVH can help be the first step in identifying a component, as different components have NVH issues at different frequencies, e.g. transmission high frequency, driveline imbalance a lower frequency. Also the NVH can be compared relative to the vehicle motion and/or engine speed. Therefore, other sensor comparisons may also take place to determine if the NVH frequency match other components, e.g. engine speed sensor. Based on the frequency of NVH the controller 110 may be able to determine where the noise is occurring For example, in time with vehicle speed the component is at or near the wheel and likely part of a drive or suspension component. If frequency corresponds with engine speed it may be a powertrain related component. If frequency occurs only during a brake application in may be a braking component, etc. Further, data comparisons may be help to pinpoint the exact component, i.e. second order NVH may be rear U-joints while third order NVH may be front CV joints. One skilled in the art would be able to determine for certain components at which frequency any NVH would occur.

Implementations may include one or more of the following features. The method where determining whether there is an NVH issue further includes: diagnosing a performance level for each of the components 804; comparing the performance level for each component to a component performance standard, 806; determining service of that component is desired based on the comparison 808; The method where the diagnosing a performance level for each component includes at least one of: comparing the component performance to performance of the same component on other modules in the fleet, and to a standard performance level for that component for vehicles of a similar type, and to a standard performance level for that component for vehicles of similar usage. The method where the component performance standard includes at least a first category for acceptable performance, a second category for degrading performance in which service will be desired within a predicted amount of time, and a third category for unacceptable performance in which service will be desired at the earliest opportunity. The method where the component performance standard includes a fourth category of performance which is inoperable until service is performed. The method further including instructing a controller on the vehicle to drive to a preset location at a preset time for service.

The integration of these components enables a method of servicing the vehicle that can offer new and novel features and services such as: prognostic services, data collection and distribution, in field preventive maintenance/repairs

The invention is not limited to the exemplary embodiment described above. To a far greater extent, other variants of the invention can be derived by persons skilled in the art without departing from the object of the invention. In particular, all individual features described in connection with the exemplary embodiment can also be combined in other ways with each other without departing from the object of the invention.

What is claimed is:

1. A method of diagnosing a mechanical problem on a vehicle comprising:
collecting data from individual sensors;
determining from the data whether is an NVH issue on the vehicle; and
providing an alert when there is an NVH issue detected.

2. The method of claim 1, wherein determining whether there is an NVH issue further comprises:
diagnosing a performance level for each of the components;
comparing the performance level for each component to a component performance standard;
determining service of that component is desired based on the comparison;

3. The method of claim 2, wherein the diagnosing a performance level for each component comprises at least one of: comparing the component performance to performance of the same component on other modules in the fleet, and to a standard performance level for that component for vehicles of a similar type, and to a standard performance level for that component for vehicles of similar usage.

4. The method of claim 2, wherein the component performance standard includes at least a first category for acceptable performance, a second category for degrading performance in which service will be desired within a predicted amount of time, and a third category for unacceptable performance in which service will be desired at the earliest opportunity.

5. The method of claim 2, wherein the component performance standard includes a fourth category of performance which is inoperable until service is performed.

6. The method of claim 1, further comprising instructing a controller on the vehicle to drive to a preset location at a preset time for service.
